(19) United States
(12) Patent Application Publication
(10) Pub. No.: US 2005/0283633 A1
(43) Pub. Date: Dec. 22, 2005

(54) Method and system for securing a device

(76) Inventors: Ron Kozenitzky, Petach Tikva (IL); Yanki Margalit, Ramat-Gan (IL); Dany Margalit, Ramat-Gan (IL)

Correspondence Address: DR. MARK FRIEDMAN LTD.;C/o Bill Polkinghorn, Discovery Dispatch, 9003 Florin Way, Upper Marlboro, MD, 20772, US

(21) Appl. No.: 10/870,034

(22) Filed: Jun. 18, 2004

(51) Int. Cl. G06F 1/04; G06F 1/12; G06F 5/06

(52) U.S. Cl. 713/600

(57) ABSTRACT

The present invention is directed to a method and system for securing a device (e.g. a security token). The method comprising the steps of: providing physical actuation mechanism (e.g. a switch) to the device; disabling some function(s) of the device (e.g. the communication channel with the host); upon actuating the physical actuation mechanism, enabling the disabled function(s). The method further comprises disabling the enabled function(s) of the device after a time period, or after the enabled function(s) has been completed. This way the disabled function(s) of the device can be activated only by the user thereof, in contrary to a hacker, which cannot physically access the actuation mechanism.

### FIELD OF THE INVENTION

The present invention relates to the field of security. More particularly, the present invention relates to a method and system for securing a device.

### BACKGROUND OF THE INVENTION

A security token is a portable handheld device, usually of small size, for providing security related functionalities such as authentication, authorization to access a network, password related functionality and so forth.

The first generation of security tokens were used merely as storage means for a PIN (Personal Identification Number). However, the recent generation of security tokens provide smartcard functionality, thus providing a programming ability which can be used for a wide range of functionalities such as one time password to ciphering, PKI (Public Key Infrastructure), digital signatures and so on.

As a peripheral device to a host, a security token has to be connected to the host via communication means. Such a connection may be wired (e.g. USB—Universal Serial Bus) or wireless (e.g. infrared or RF—Radio Frequency like Bluetooth).

A typical example of a security token is the eToken manufactured by Aladdin Knowledge Systems, www.eAladdin.com.

A security token may provide an extra level of assurance through a method known in the art as two-factor authentication: the user has a personal identification number (PIN), which authorizes him as the owner of that particular device. The device then displays a number which uniquely identifies the user to a service, allowing the user to log in. The identification number for each user is changed frequently, usually every five minutes or so.

One of the common applications of security tokens is in the field of banking. In order to assure that only the owner of an account is able to initiate banking transactions on his account, the owner is provided with a security token, whereby its presence is verified by the host system whenever the owner accesses his bank account. At the time the security token is connected to the host (or terminal), a hacker has a theoretical chance to take control over the bank account since the security token is connected to the computer.

It is an object of the present invention to provide a method and system for securing a device.

It is a further object of the present invention to provide a method and system for increasing the security level provided by a security token while the security token is connected to a host.

Other objects and advantages of the invention will become apparent as the description proceeds.

### SUMMARY OF THE INVENTION

The present invention is directed to a method and system for securing a device (e.g. a security token). The method comprising the steps of: providing physical actuation mechanism (e.g. a switch) to the device; disabling some function(s) of the device (e.g. the communication channel with the host); upon actuating the physical actuation mechanism, enabling the disabled function(s). The method further comprises disabling the enabled function(s) of the device after a time period, or after the enabled function(s) has been completed. This way the disabled function(s) of the device can be activated only by the user thereof, in contrary to a hacker, which cannot physically access the actuation mechanism.

### BRIEF DESCRIPTION OF THE DRAWINGS

The present invention may be better understood in conjunction with the following figures:

FIG. 1 schematically illustrates a communication between a security token and a host system, according to the prior art.

FIG. 2 schematically illustrates a security token, according to a preferred embodiment of the present invention.

FIG. 3 is a flowchart of a method for increasing the security of a security token, according to a preferred embodiment of the invention.

FIG. 4 is a table describing some of the possibilities for implementing an actuating switch/sensor.

FIG. 5 schematically illustrates a security token, according to a preferred embodiment of the invention.

FIG. 6 schematically illustrates a security token, according to another preferred embodiment of the invention.

### DETAILED DESCRIPTION OF PREFERRED EMBODIMENTS

The detailed description of the preferred embodiments refer herein to a security token. However, it should be noted that the invention may be implemented by any device. The examples herein refer to a security token, since in addition to the security-related functionality it provides, also its operation should be secured, thereby gaining higher security level.

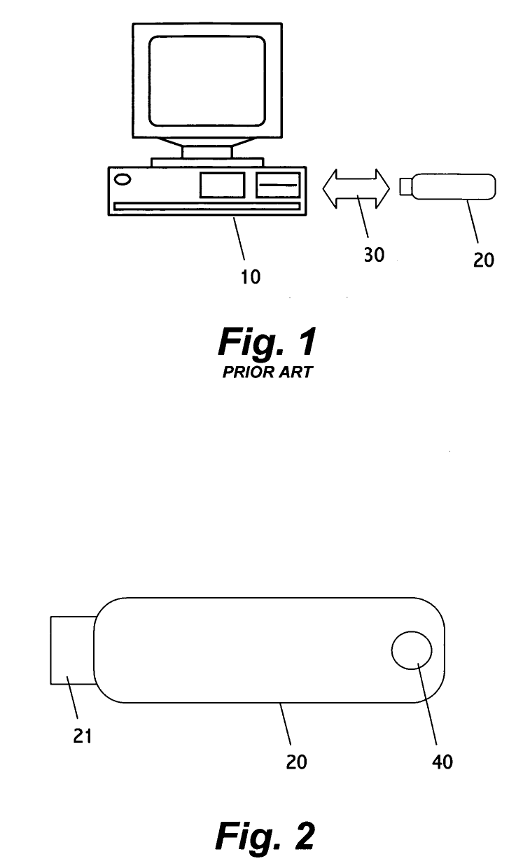

FIG. 1 schematically illustrates a communication between a security token and a host system, according to the prior art. The security token 20 is an external device to the host system 30. The communication between the security token and the host system is carried out via communication channel 30, which may be, for example, USB, RS232, IrDA (an infrared communication standard), Bluetooth (a radio communication standard), Wi-Fi, and so forth. Upon inserting the security token 20 into the appropriate socket of the host system 10 (in case of wired communication), the PIN (Personal Identification Number) is provided by the security token 20 to the host system 10. Such an authentication process is called in the art “One Factor Authentication”.

FIG. 2 schematically illustrates a security token, according to a preferred embodiment of the present invention. The security token 20 is coupled with a connector 21 (e.g. a USB connector) to a host, and physical actuation mechanism 40. Upon actuating the physical actuation mechanism 40 a functionality of the security token becomes available for a time period. After the time period expires, the functionality of the security token becomes unavailable until the next actuation.

The method of the present invention will be better understood with a practical example of a user that secures his activity to an online bank by a security token. In this particular example, the user communicates with the bank server over the Internet by a browser that runs on the user's personal computer (i.e. a host). The communication with the bank server is enabled only when the security token is connected to the personal computer. For example, data to be sent from the user's computer to the bank server is firstly sent from the personal computer to the security token where it is encrypted with a private key of the user, and therefrom returned to the personal computer which sends it (in its encrypted form) to the bank server. Thus, a hacker that intends to perform illegal operations on the user's bank account can do it only when the security token is connected to the personal computer.

There are a variety of hacking methods known in the art. For example, a hacker can remotely operate a user's computer with a program such as Remote Administrator, upon which a hacker can view the user's screen and also control the user interface of the remote computer by the remote input means, such as keyboard and mouse. Thus, a hacker can actually take control over a user's computer even without the knowledge of the user. However, if the user has installed a security token to secure his activity with the bank's server, the hacker can perform operations on the user's bank account only when the token is plugged into the user's computer.

Unfortunately the security token still does not cover all the possibilities of a hacker to remotely perform transactions in the user's bank account via the user's computer, since the hacker can do it while the security token is plugged in. According to the present invention the possibilities to remotely operate the user's bank account by a hacker are diminished by adding physical actuation mechanism to the security token. By the physical actuation mechanism only a user that can physically access these means can actuate his security token. Thus, before sending data to the bank server, a user has to actuate his security token physically. Consequently, a hacker that tries to remotely control the user's computer will be able to do so only in a short time period after the user has actuated his security token.

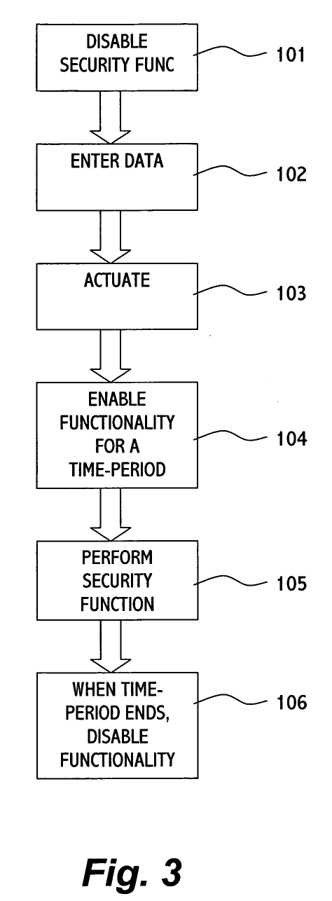

FIG. 3 is a flowchart of a method for increasing the security of a security token, according to a preferred embodiment of the invention. Referring to the above example:

On block 101, a default security functionality provided by the security token is disabled. For example, the communication between the security token and the host is suspended.

On block 102, the user enters data using a user interface thereof. For example, the user enters an instruction of buying shares in a stock market. Typically the user has to click a SEND button or alike in order to trigger sending the information to the bank's server, however, since the security token is disabled, the user has to perform a preliminary operation for enabling this operation.

On block 103, the user actuates the actuation mechanism coupled to the token. For example, he turns on a switch.

As a result, on block 104 the security token enables the disabled functionality (e.g. the communication with the host) for a time period.

On block 105, if the user clicks on the SEND button of the user interface during this time period, the token performs the disabled functionality, i.e. communicates with the user's personal computer in order to get the data, encrypts it and returns it to the security token, from which the encrypted data is sent to the corresponding server.

On block 106, which takes place after the time period expires, the token returns to its disabled state. According to a preferred embodiment of the invention the token returns to its disabled state after the started operation has been ended. For example, the token returns to its disabled state only after the encrypted data has been sent to the host, even if it takes more than the planned time period.

This way only the user may enable the disabled functionality of a token, since the enablement is carried out only by physical means to the host, an operation which can be carried out only by physical contact with the token. A hacker which gets a remote control over the user's computer still cannot actuate the token since he cannot touch it and as a result the security provided by the security token becomes higher than in any other alternative, i.e. without a physical trigger.

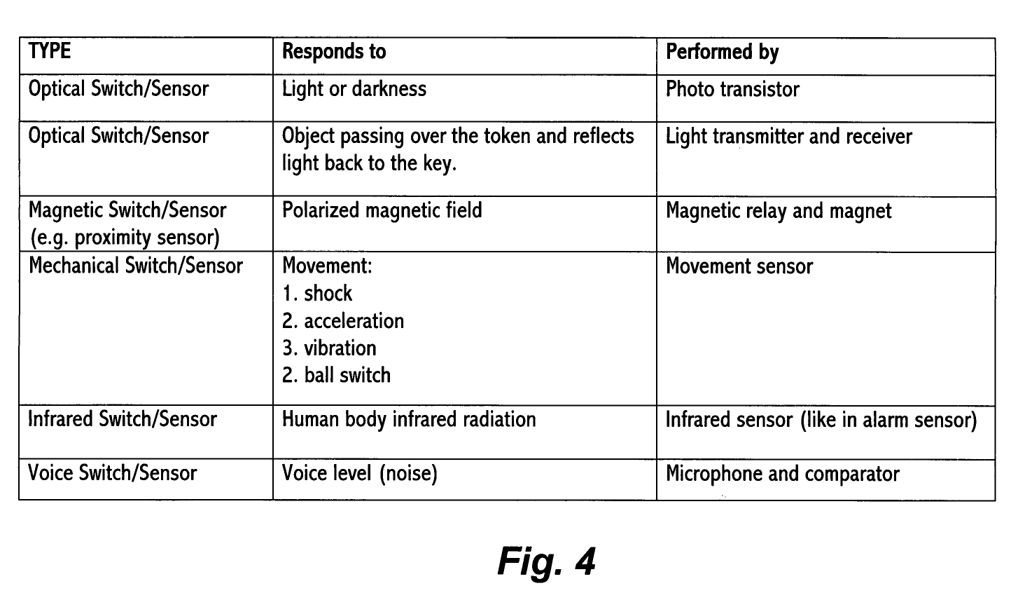

FIG. 4 is a table describing some of the possibilities for implementing an actuating switch/sensor. Those skilled in the art will appreciate that other alternatives can be used.

A more sophisticated way to achieve the same results can be by adding to the security token a sensor that is capable of detecting any movement of the token, e.g. as a result of human touch. For example, in keyboards that comprise a USB socket, to which a security token can be connected, upon clicking a key of the keyboard, any key, the vibrations are sensed by a corresponding sensor of the security token and its disabled functionality gets enabled for a time period. This way the user actually doesn't have to take care of activating the security token, since it is carried automatically.

Another way to automate the process can be achieved by infrared communication means, as follows: assuming that the mouse attached to the user's computer communicates with the host by infrared communication means, the security token can also be coupled with infrared interface in order to intercept the transmissions from the mouse. Upon indication of a click, the token may enter into its active state for a time period.

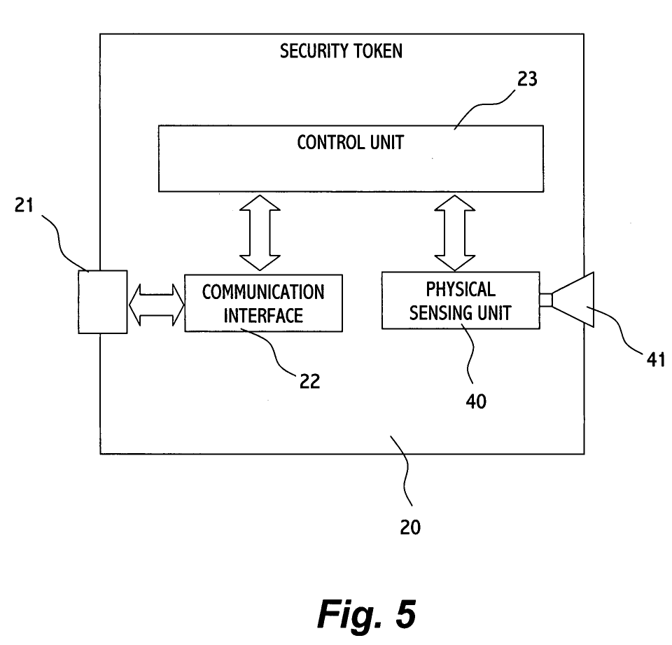

FIG. 5 schematically illustrates a security token, according to a preferred embodiment of the invention. Security token 20 is coupled with a communication interface 22 (e.g. USB), to be connected to a host via connector 21. The physical actuation mechanism 40 typically comprises a sensor 41 (e.g. optical switch) and corresponding circuitry (not shown). The communication interface 22 and the physical actuation mechanism 40 are connected to a control unit 23 (e.g. a smart card chip). Typically, the security token uses a power source (not shown), which may be provided by its own source (e.g. a battery), or an external source (e.g. from the host by a USB interface).

In a typical implementation of the present invention, the communication between a host (not shown) and the security token 20 is disabled. Upon actuating the physical actuation mechanism 40, the control unit 23 which is connected to the physical actuation mechanism 40, enables communication between the host and the security token 20.

According to one embodiment of the invention, the communication is enabled only for a time period, and afterwards the communication gets disabled again. According to another embodiment of the invention, the communication remains enabled as long as the physical actuation mechanism is actuated, and becomes again disabled when the physical actuation mechanism is de-actuated. According to another embodiment of the invention once the communication has been enabled, it stays that way.

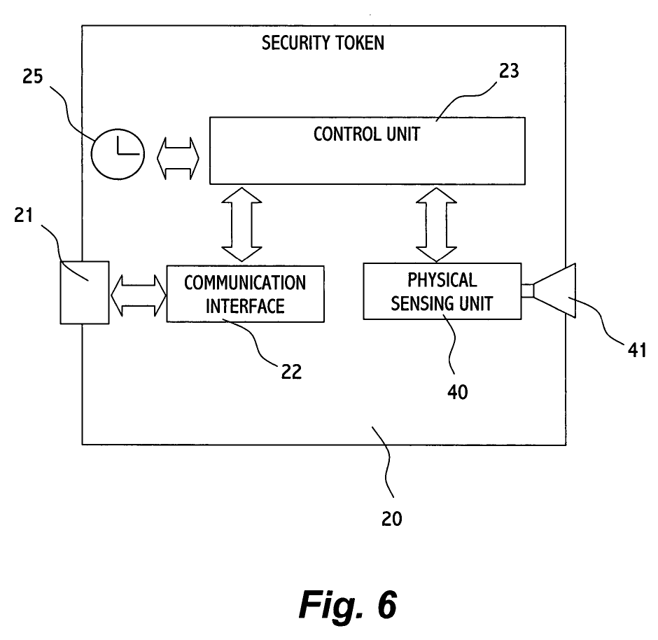

FIG. 6 schematically illustrates a security token, according to another preferred embodiment of the invention. Security token 20 is coupled with a communication interface 22 (e.g. USB), to be connected to a host via connector 21. The physical actuation mechanism 40 typically comprises a sensor 41 (e.g. optical switch) and corresponding circuitry (not shown). The communication interface 22 and the physical actuation mechanism 40 are connected to a control unit 23 (e.g. a smart card chip). Typically, the security token is coupled with a power source (not shown).

In a typical implementation of the present invention, the communication between a host (not shown) and the security token 20 is disabled. Upon actuating the physical actuation mechanism 40, the control unit 23 which is connected to the physical actuation mechanism 40, enables the communication between the host and the security token 20 for predefined a time period, after which the communication is re-disabled. In order to cont the time period, the security token is provided with a clock device 25. Typically the clock device 25 is connected to the control unit 23.

Those skilled in the art will appreciate that the invention can be embodied by other forms and ways, without losing the scope of the invention. The embodiments described herein should be considered as illustrative and not restrictive.

1. A method for increasing a security level of a device, said method comprising:
providing a physical actuation mechanism for actuating said device;
disabling at least one function of said device; and
upon actuating said physical actuation mechanism, enabling said at least one function.

2. A method according to claim 1, further comprising:
subsequent to said actuating, again disabling said at least one function of said device.

3. A method according to claim 2, wherein said at least one function of said device is again disabled after a preselected time period subsequent to said actuating.

4. A method according to claim 2, wherein said at least one function of said device is again disabled after said function has been completed.

5. A method according to claim 1, wherein said device is selected from a group comprising: a computer, a security token.

6. A method according to claim 1, wherein said physical actuation mechanism is selected from a group comprising: at least one mechanical sensor, at least one optical sensor, at least one electrical sensor, at least one magnetic sensor, at least one infrared sensor, and at least one voice sensor.

7. A method according to said claim 1, wherein said at least one function of said device is selected from a group comprising: communicating with a host, receiving input from a host, sending output to a host, authenticating a user, ciphering data, digitally signing data.

8. A system for increasing a security level of a device, said system comprising:
physical actuation mechanism;
a control module connected to said physical actuation mechanism and operative to enable at least one function of said device after said physical actuation mechanism is actuated.

9. A system according to claim 8, further comprising a clock device, for limiting the enablement to a preselected time period.

10. A system according to claim 8, wherein said device is selected from a group comprising: a computer, a security token.

11. A system according to claim 8, wherein said physical actuation mechanism is selected from a group comprising: at least one mechanical sensor, at least one optical sensor, at least one electrical sensor, at least one magnetic sensor, at least one infrared sensor, at least one voice sensor.

12. A system according to claim 8, wherein said at least one function of said device is selected from a group comprising: communicating with a host, receiving input from a host, sending output to a host, authenticating a user, ciphering data, digitally signing data.
